(19) United States
(12) Patent Application Publication
(10) Pub. No.: US 2023/0267291 A1
(43) Pub. Date: Aug. 24, 2023

(54) DETERMINING THE AUTHENTICITY OF AN OBJECT

(71) Applicant: ams International AG, JONA (CH)

(72) Inventor: Dewight Warren, Dallas, TX (US)

(73) Assignee: ams International AG, JONA (CH)

(21) Appl. No.: 18/006,909

(22) PCT Filed: Jul. 27, 2021
(86) PCT No.: PCT/EP2021/070945

§ 371 Date: Jan. 26, 2023

(30) Foreign Application Priority Data
Jul. 29, 2020 (GB) 2011767.7

(51) Int. Cl. G06K 7/12; G06K 7/10

(52) U.S. Cl. CPC G06K 7/12; G06K 7/10841; G06K 7/10861; G06K 7/10831

(57) ABSTRACT

A device comprising: an optical emitter for emitting light having an emitted optical spectrum; an optical sensor for receiving light reflected from a tag attached to an object; and a processor configured to: determine a reflected optical colour spectrum of the light reflected from the tag based on an output of the optical sensor; retrieve an optical signature associated with said object from memory; and determine the authenticity of said object based on comparing the optical signature and the reflected optical colour spectrum.

### CROSS-REFERENCE TO RELATED APPLICATIONS

The present application is the national stage entry of International Patent Application No. PCT/EP2021/070945, filed on Jul. 27, 2021, and published as WO 2022/023311 A1 on Feb. 3, 2022, which claims priority to GB Application No. 2011767.7, filed on Jul. 29, 2020, all of which are incorporated by reference herein in their entireties.

### FIELD OF THE DISCLOSURE

This disclosure relates to determining the authenticity of an object. In particular, this disclosure uses light reflected from a tag attached to the object to determine the authenticity of the object.

### BACKGROUND

Authentication is an application where one device (or entity) is able to discern with a high level of confidence that another device is of a known source or identity. Typically the device (reader) that desires to authenticate another device will initiate accessing information from another device (tag). In a first step, the reader requests an information from the tag that uniquely identifies the tag and in a second step, the tag responds with the requested information.

There are a number of known authentication mechanisms. These include (i) electrical authentication whereby a direct electrical connection is made between a reader and a tag; (ii) wireless (RF) authentication uses radio signals (like Near Field Communications) to communicate between the reader and the tag; and (iii) Infrared taggants use an infrared light source in the reader to excite chemical taggants that will fluoresce at unique wavelength patterns.

### SUMMARY

The inventor has identified a number of problems with the known authentication mechanisms. When implementing electrical authentication it is difficult to achieve a compact reader due to the requirement of facilitating a physical connecter for communication with the tag. Similarly, when implementing wireless (RF) authentication it is difficult to achieve a compact reader due to the requirement of facilitating an antenna for communication with the tag. Finally, solutions utilising infrared taggants require a sophisticated light source which increases the complexity of the reader.

In general terms, this disclosure relates to an authentication system using reflected optical wavelength patterns. An authentication reader is used which comprises a light source and an optical sensor that can measure the amount of light within certain bands of wavelengths. The spectral emitted power from the light source hits an authentication tag that can be adhered to an object to be authenticated. Due to one or more optical filters on the authentication tag (that are unique to the object) light is reflected back from the tag to the authentication reader. The optical sensor measures the reflected optical colour spectrum of the light reflected from the tag and uses this to determine the authenticity of the object.

According to one aspect of the present disclosure there is provided a device comprising: an optical emitter for emitting light having an emitted optical spectrum; an optical sensor for receiving light reflected from a tag attached to an object; and a processor configured to: determine a reflected optical colour spectrum of the light reflected from the tag based on an output of the optical sensor; retrieve an optical signature associated with said object from memory; and determine the authenticity of said object based on comparing the optical signature and the reflected optical colour spectrum.

Thus the device is advantageously able to determine the authenticity of an object using a compact reader without requiring a complex reader.

In implementations, the emitted optical spectrum is associated with a wavelength range which comprises wavelengths of light that the tag is arranged to reflect.

In implementations, the optical sensor is configured to measure light in a measurable wavelength range which comprises wavelengths of light that the tag is arranged to reflect.

The reflected optical colour spectrum may comprise, for each of a plurality of wavelength bands, a ratio of optical power of the light reflected from the tag to optical power of the light emitted by the optical emitter.

In these embodiments, the output of the optical sensor may comprise an optical power measurement of the light reflected from the tag for each of the plurality of wavelength bands. Alternatively, the output of the optical sensor may comprise the reflected optical colour spectrum.

In implementations, the optical signature comprises, for each of the plurality of wavelength bands, a target ratio of optical power of light reflected from the tag to optical power of light emitted by the optical emitter.

Based on said determination of the authenticity of said object, the processor may be configured to output an authentication result to a user of said device via an output device of said device, the authentication result indicating authentication success or authentication failure.

The output device may comprise a display. Additionally or alternatively, the output device comprises a speaker.

The device may comprise said memory. Alternatively, a remote device comprises the memory, and the device comprises a communications interface for communicating with the remote device for retrieving said optical signature.

The optical emitter may emit visible light. For example the optical emitter may be a white LED. Thus the authenticity of an object can be determined using a low complexity, low cost light source.

According to another aspect of the present disclosure there is provided a computer implemented method for authenticating an object, the method performed on a device and comprising: controlling an optical emitter of said device to emit light having an emitted optical spectrum; determining a reflected optical colour spectrum of light reflected from a tag attached to the object based on an output of an optical sensor of said device; retrieving an optical signature associated with said object from memory; and determining the authenticity of said object based on comparing the optical signature and the reflected optical colour spectrum.

According to another aspect of the present disclosure there is provided a non-transitory computer-readable storage medium comprising instructions which, when executed by a processor of a device cause the processor to perform any of the methods described herein.

The instructions may be provided on a carrier such as a disk, CD- or DVD-ROM, programmed memory such as read-only memory (Firmware), or on a data carrier such as an optical or electrical signal carrier. Code (and/or data) to implement embodiments of the present disclosure may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language.

According to another aspect of the present disclosure there is provided a system comprising: a device comprising an optical emitter for emitting light having an emitted optical spectrum; and a tag attached to an object, the tag comprising: a base layer of optically absorptive material; and at least one optical filter, each of the least one optical filter configured to pass light having a wavelength in one or more portions of the emitted optical spectrum through to the base layer and reflect light having a wavelength in remaining portions of the emitted optical spectrum; wherein the device further comprises: an optical sensor for receiving light reflected from the tag; and a processor configured to: determine a reflected optical colour spectrum of the light reflected from the tag based on an output of the optical sensor; retrieve an optical signature associated with said object from memory; and determine the authenticity of said object based on comparing the optical signature and the reflected optical colour spectrum.

The system provides a secure authentication mechanism as it is difficult for a malicious entity to replicate an authentic tag for application on counterfeit goods with sufficient accuracy such that the device's authentication check would be passed.

The at least one optical filter may be on a surface of the base layer of optically absorptive material. Alternatively, the tag may comprise a transparent substrate and the at least one optical filter is on a surface of the transparent substrate.

The tag may comprises a single optical filter. This simplifies the design of the tag. Alternatively the tag comprises a plurality of optical filters. This facilitates the creation of a very specific spectral response from the tag. In particular, the use of a plurality of optical filters increases the number of possible unique reflected optical spectrums from which a particular tag can be configured to generate which advantageously enables scalability for authenticating a large number of different unique objects.

The plurality of optical filters may be stacked in a vertical arrangement. Alternatively, the plurality of optical filters may be arranged in a single horizontal plane in a side by side arrangement, this advantageously enables the height of the tag to be minimised.

The embodiments of any one of the aspects of the invention descried herein are applicable to any of the other aspects of the invention.

These and other aspects will be apparent from the embodiments described in the following. The scope of the present disclosure is not intended to be limited by this summary nor to implementations that necessarily solve any or all of the disadvantages noted.

### BRIEF DESCRIPTION OF THE DRAWINGS

Some embodiments of the disclosure will now be described by way of example only and with reference to the accompanying drawings, in which:

FIG. 1 illustrates an authentication system comprising a device and a tag;

FIG. 2 is a schematic block diagram of the device;

FIG. 3 illustrates optical filters which may be present on the tag;

FIG. 4a illustrates an example optical spectrum of light emitted by an optical emitter of the device;

FIG. 4b illustrates the spectral responsivity of an example 8-channel optical sensor of the device;

FIG. 5a illustrates the normalized tag reflectivity of an example tag;

FIG. 5b illustrates an example optical spectrum of light received by the optical sensor of the device that has been reflected from the tag;

FIG. 5c illustrates both the example optical spectrum of light emitted by the optical emitter shown in FIG. 4a and the example optical spectrum of light received by the optical sensor shown in FIG. 5b; and

FIG. 6 is a flow chart of a process performed by the device in accordance with embodiments described herein.

### DETAILED DESCRIPTION

Specific embodiments will now be described with reference to the drawings.

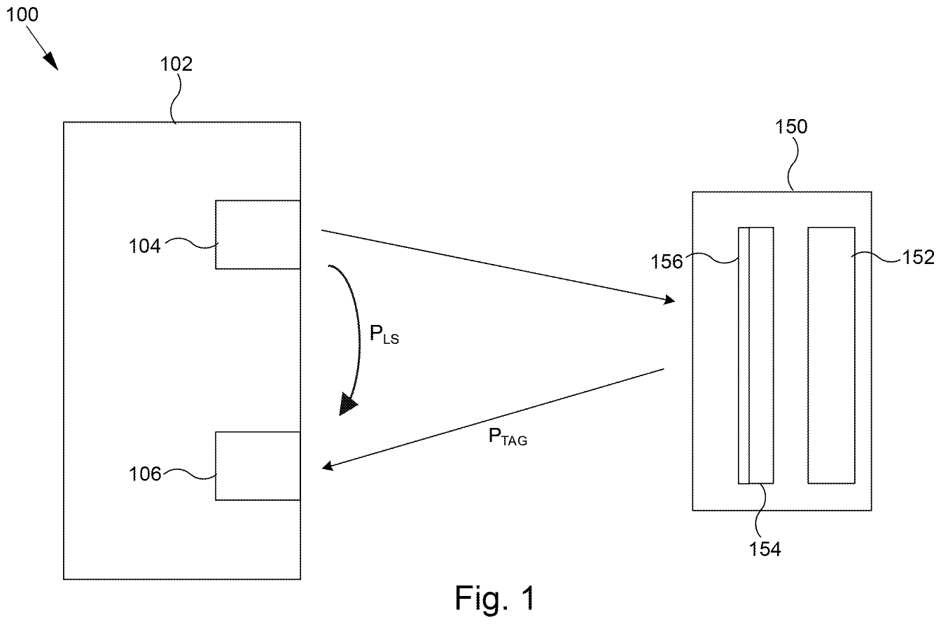

FIG. 1 illustrates an authentication system 100 comprising a computing device 102 (also referred to herein as a device) and an authentication tag 150 (also referred to herein as a tag).

As shown in FIG. 1, the device 102 comprises an authentication reader which comprises an optical emitter 104 (otherwise referred to herein as a light source) for emitting light having an emitted optical spectrum, and an optical sensor 106 for measuring light reflected from the tag 150 in one or more wavelength bands.

The tag 150 is to be adhered to an object that is to be authenticated e.g. a bottle of wine.

The tag 150 comprises at least one optical filter 156. Each of the least one optical filter is configured to pass light having a wavelength in one or more portions of the emitted optical spectrum through to the base layer and reflect light having a wavelength in remaining portions of the emitted optical spectrum. That is, the tag is associated with a unique optical signature which represents a spectrum of light which will be reflected back to the authentication reader when light emitted by a particular type of light source is incident on the tag. The tag 150 can be produced with a compact size e.g. ˜1 mm².

The tag 150 also comprises a base layer 152 of optically absorptive material e.g. a material with a reflectivity of less than 5% (black materials typically have a reflectivity of less than 5%). The at least one optical filter 156 is applied to a rigid structure of the tag 150. As shown in FIG. 1, the at least one optical filter 156 may be applied to transparent substrate 156 which is then positioned on the base layer 152. The transparent substrate 156 may be made of glass, however other materials are possible. Alternatively, the transparent substrate 156 is not present and the at least one optical filter 156 may be applied to the base layer 152.

Taking the example of the object that is to be authenticated being a bottle of wine, a wine producer producing 1 million bottles of wine of a particular type (defined by for example the colour, region, year etc.) may have each of these bottles labelled with a tag which is associated with the same optical signature that is unique to the particular type of bottle of wine. As will be described in more detail below, embodiments of the present disclosure enable a user of the device 102 to determine, when considering buying such an object, that the object is authentic (i.e. determine that the object is not counterfeit).

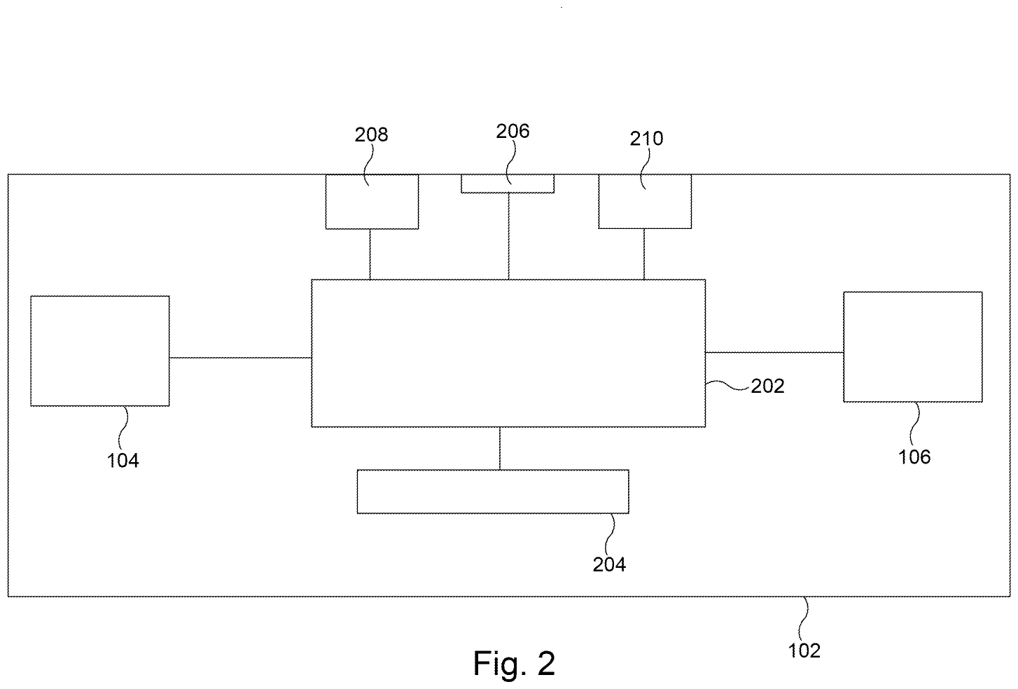

FIG. 2 illustrates a simplified view of the device 102. The device 102 may be any computing device for example a mobile phone, tablet, personal computer, laptop or a wearable device (e.g. a smartwatch or smart glasses) etc.

As shown in FIG. 2, the device 102 comprises a central processing unit (“CPU”) 202, to which is connected a memory 204. The functionality of the CPU 202 described herein may be implemented in code (software) stored on a memory (e.g. memory 204) comprising one or more storage media, and arranged for execution on a processor comprising one or more processing units. That is, the device 102 may comprise one or more processing units for performing the processing steps described herein. The storage media may be integrated into and/or separate from the CPU 202. The code is configured so as when fetched from the memory and executed on the processor to perform operations in line with embodiments discussed herein. Alternatively it is not excluded that some or all of the functionality of the CPU 202 is implemented in dedicated hardware circuitry (e.g. ASIC(s), simple circuits, gates, logic, etc.) and/or configurable hardware circuitry like an FPGA.

The memory 204 may store an optical signature associated with the object that is to be authenticated. Alternatively this optical signature may be stored in a memory of a remote device (e.g. a server) that the device 102 can query and access data from.

The CPU 202 is coupled to the optical emitter 104. The CPU 202 is configured to control the optical emitter 104 to emit light in response to receipt of user input via an input device 208. The optical emitter 104 may emit visible light (typically, the human eye can detect wavelengths from 380 to 700 nm), for example the optical emitter 104 may be a white light emitting diode (LED). It will be appreciated that embodiments of the present disclosure are not limited to the use of an optical emitter that emits visible light, for example the optical emitter 104 may be an infrared emitter, other light sources may also be used. In embodiments, the emitted optical spectrum is associated with a wavelength range which comprises wavelengths of light that the tag 150 is arranged to reflect (i.e. the emitted light has the wavelengths of interest in it).

The CPU 202 is also coupled to the optical sensor 106. The optical sensor 106 is configured to measure a reflected optical colour spectrum of the light reflected from the tag 150. In embodiments, the optical sensor is configured to measure light in a measurable wavelength range which comprises wavelengths of light that the tag 150 is arranged to reflect.

The optical emitter 104 and the optical sensor 106 may be separate components as shown in FIG. 2 or they may be housed within the same package/module within the device 102.

The CPU 202 is coupled to an input device 208 which allows a user of the device 102 to trigger an authentication process described in more detail below. The input device 208 may for example be a keypad, keyboard, a touch sensitive display, or a microphone.

The CPU 202 is also coupled to an output device 210. The CPU 202 is configured to output a result of the authentication process described in more detail below to the user of the device 102 via the output device 210. The output device may be a display (e.g. the touch sensitive display referred to above) to output a visual authentication result or a speaker to output an audible authentication result.

The CPU 202 may also be coupled to a communications interface 206 such as a wired or wireless communication interface. The communications interface 206 enables a user to retrieve the optical signature, which is associated with the object that is to be authenticated, from a trusted source. For example the optical signature associated with the object may be downloaded via the communications interface 206 from an app store or website. It will be appreciated that the device 102 may obtain the optical signature associated with the object in a number of different ways. For example, the device 102 may receive an email via the communications interface 206 which comprises the optical signature which is then stored in memory 204. In other implementations, the communications interface 206 is not used in the device obtaining the optical signature associated with the object. For example a camera of the device 102 (not shown in FIG. 2) may scan a QR code to retrieve the optical signature, or the optical signature may be uploaded to memory 204 from a portable memory device (e.g. a USB stick).

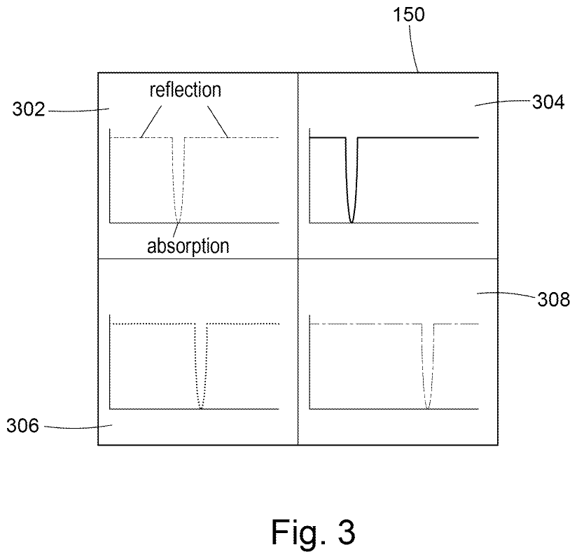

FIG. 3 illustrates an example authentication tag 150. The tag 150 comprises one or more optical filters 156. The tag 150 shown in FIG. 3 comprises four optical filters 302, 304, 306, 308, however this is merely an example and any number of optical filter may be chosen. Example filter responses associated with each of the four optical filters are also shown in FIG. 3 which illustrate the reflection (y-axes) versus wavelength (x-axis) properties of each optical filter. The four optical filters shown in FIG. 3 are band-pass filters that are each configured to pass light in a particular wavelength band of the emitted optical spectrum through to the base layer 152 and reflect light having a wavelength in the remaining portions of the emitted optical spectrum back towards the optical sensor 106. In embodiments of the present disclosure, each optical filter may be one of a high-pass, low-pass, band-pass, or band-stop filter.

One or more of the optical filter(s) 156 may be an interference filter. As is known to persons skilled in the art, an interference filter comprises multiple thin layers of dielectric material having different refractive indices which can be patterned onto a supporting structure e.g. the transparent substrate 154 or base layer 152. Other forms of optical filter are possible.

In embodiments whereby the tag 150 comprises multiple optical filters, the plurality of optical filters may be stacked on top of each other in a vertical arrangement. Alternatively, the plurality of optical filters may be arranged in a single horizontal plane in a side by side arrangement covering the upper surface of the tag 150.

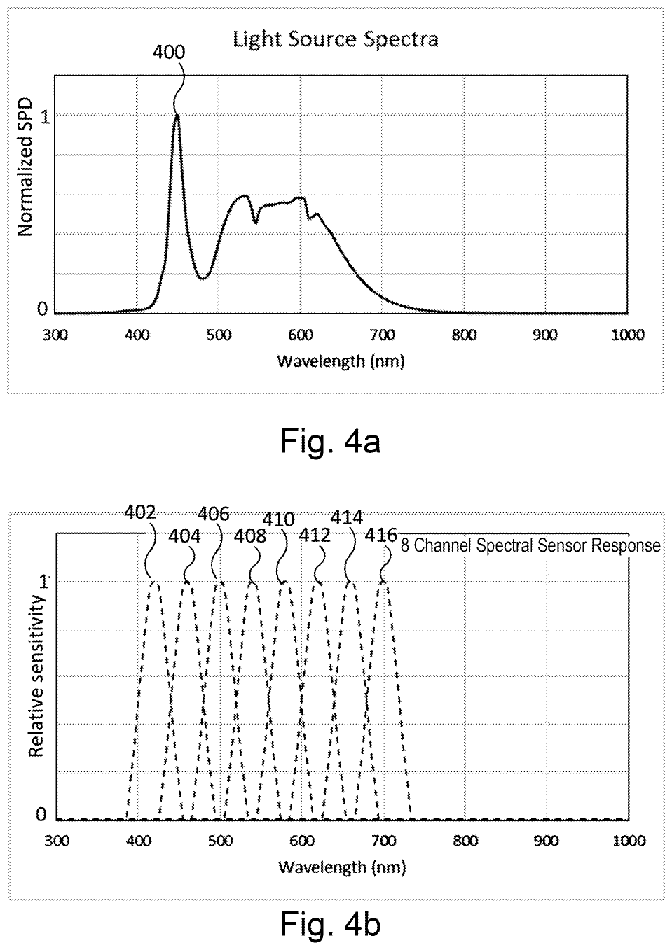

We refer to an example whereby the optical emitter 104 is a white LED (abbreviated herein as a “WLED”). The white LED 104 emits light having wavelengths in the range of 300-1100 nm and the spectral power (which may be measured in μW/cm2) of light emitted by the white LED 104 at each wavelength in this range varies. FIG. 4a illustrates the normalized Spectral Power Distribution (SPD) of the light having an emitted optical spectrum 400 that may be emitted by the white LED 104 with each wavelength having a normalized spectral power value.

FIG. 4b illustrates the normalized spectral responsivity of an optical sensor which comprises 8 channels. Each channel of the optical sensor is used to measure light in a particular wavelength band. It will be appreciated that embodiments of the present disclosure are not limited to this particular type of optical sensor and any sensor that can measure light reflected from the tag 150 in one or more wavelength bands may be used. The example optical sensor illustrated in FIG. 4 comprises a first channel 402 that is configured to measure light in a first wavelength band e.g. 390-450 nm, a second channel 404 that is configured to measure light in a second wavelength band e.g. 430-490 nm, a third channel 406 that is configured to measure light in a third wavelength band e.g. 470-530 nm, a fourth channel 408 that is configured to measure light in a fourth wavelength band e.g. 510-570 nm, a fifth channel 410 that is configured to measure light in a fifth wavelength band e.g. 550-610 nm, a sixth channel 412 that is configured to measure light in a sixth wavelength band e.g. 590-650 nm, a seventh channel 414 that is configured to measure light in a seventh wavelength band e.g. 630-690 nm, and an eight channel 416 that is configured to measure light in an eighth wavelength band e.g. 670-730 nm.

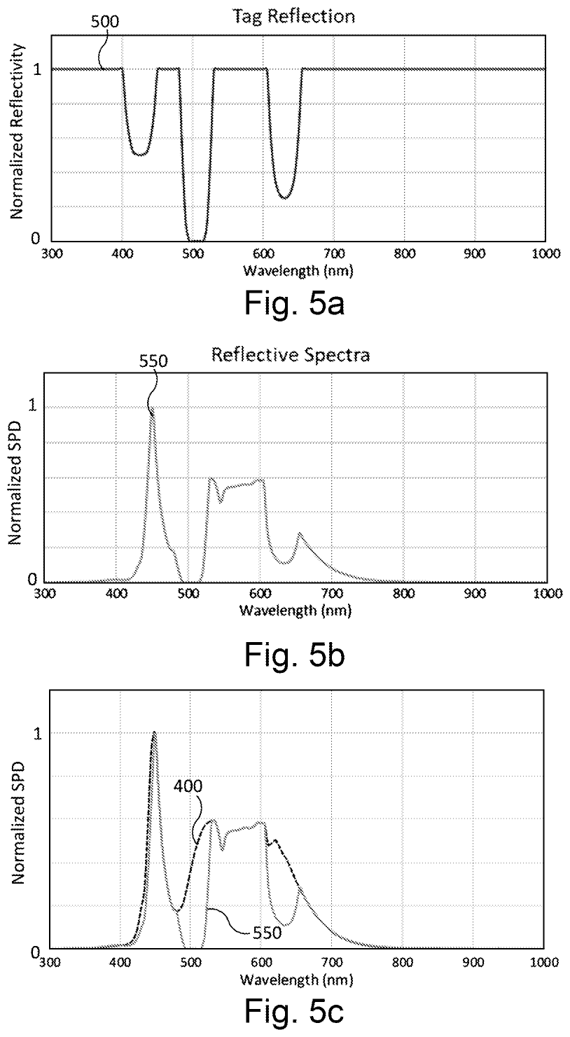

FIG. 5a illustrates the normalized value of reflectivity (in a range of between 0 and 1) of an example tag 150 for each wavelength of the emitted optical spectrum 400. These reflective properties are a direct result of the selection of the transmissive/reflective properties of the optical filter(s) 156 on the tag. The waveform 500 of the normalized values of reflectivity define the amount of reflectivity for each wavelength of the emitted optical spectrum 400, whereby a wavelength associated with a normalized value of reflectivity of 0 means that light at this wavelength will pass through the optical filter(s) 156 and be completely absorbed by the base layer 152, and a wavelength associated with a normalized value of reflectivity of 1 means that light at this wavelength will be completely reflected by the optical filter(s) 156.

FIG. 5b illustrates the normalized Spectral Power Distribution (SPD) of the light having a reflected optical colour spectrum 550 that is reflected by the tag 150 with each wavelength having a normalized spectral power value. The light represented in FIG. 5b is reflected by the tag 150 when the emitted optical spectrum 400 shown in FIG. 4a is emitted by the white LED 104 and reflected from the tag 150 having the properties shown in FIG. 5a.

In particular, for each wavelength in the reflected optical colour spectrum 550, the normalized SPD value shown therein is obtained by multiplying (i) the normalized spectral power value of the emitted optical spectrum 400 for that wavelength; and (ii) the normalized value of reflectivity of the tag for that wavelength.

To illustrate the effect of the optical filter(s) 156 on the light emitted by the optical emitter 104 having an emitted optical spectrum 400, FIG. 5c illustrates both the normalized Spectral Power Distribution (SPD) of the light having an emitted optical spectrum 400 that is emitted by the white LED 104 (that is shown in FIG. 4a) and the normalized Spectral Power Distribution (SPD) of the light having a reflected optical colour spectrum 550 that is reflected by the tag 150 (that is shown in FIG. 5b).

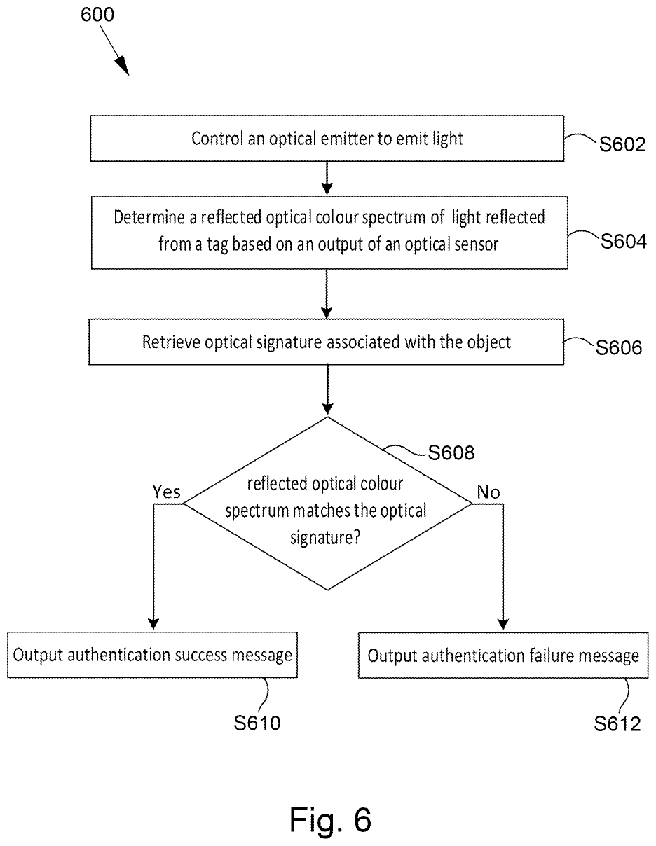

FIG. 6 illustrates an example process 600 which may be performed by the CPU 202 for authenticating an object.

Prior to the process 600 being performed, the CPU 202 controls the optical sensor 106 to measure the optical power (P_{LS}) of the light emitted by the optical emitter 104. That is, each channel of the optical sensor 106 provides a power reading indicative of the optical power (i.e. irradiance) of the light emitted by the optical emitter 104. These power reading values are stored in memory (e.g. memory 204). This can be implemented by using a surface material with a flat reflectivity across the spectrum of interest. This step may only need to be performed once as long as the spectrum of the optical emitter 104 does not change over time. The sum of each of the power reading values (also referred to herein as a “Total measured light source” value) is also stored in memory, this is shown in Table 1 as having a value of 163384.

The optical sensor 106 comprises one or more analogue-to-digital converter (ADC). These analogue-to-digital converters receive analogue inputs from a sensor array (e.g. a photodiode array) and for each channel supply a digital output corresponding to the total optical power of the light received in the wavelength band associated with that channel. It will be appreciated that if the channels are multiplexed, it is not necessary to have an analogue-to-digital converter for each channel (for example even a single analogue-to-digital converter could be used if the channels are multiplexed). Example ADC readings when the optical sensor 106 measures the optical power (P_{LS}) of the light emitted by the optical emitter 104 are shown below in Table 1.

TABLE 1

| CH1 | CH2 | CH3 | CH4 | CH5 | CH6 | CH7 | CH8 | Total |
|---|---|---|---|---|---|---|---|---|
| 9104.8 | 27388 | 20105 | 30097 | 30928 | 26659 | 14211 | 4891.7 | 163384 |

Also stored in memory is an optical signature associated with the object that is to be authenticated. The optical signature may comprise, for each channel, a target light source (e.g. WLED) to tag ratio. For each channel, each target WLED to tag ratio represents a power ratio of the optical power of the light emitted by the optical emitter 104 and the expected optical power of the light received back at the optical sensor (due to the optical properties of tag 150). The target light source (e.g. WLED) to tag ratio may be a ratio of (i) the total normalized spectral power of the WLED in the channel, and (ii) the total normalized spectral power of the reflective spectra in the channel.

Example values of the total normalized Spectral Power Distribution (SPD) of the emitted optical spectrum 400 that is shown in FIG. 4a are included in Table 2 in the row labelled “WLED”. Example values of the total normalized Spectral Power Distribution (SPD) of the reflected optical colour spectrum 550 that is shown in FIG. 5b are also included in Table 2, in the row labelled “Reflection”. For each channel, a target light source (e.g. WLED) to tag ratio value defines the ratio of these two values, it is these values (in the shaded row of Table 2) which are stored in memory.

A power ratio of the total optical power (i.e. across all channels) of the light emitted by the optical emitter 104 and the expected total optical power (i.e. across all channels) of the light received back at the optical sensor (due to the optical properties of tag 150) is also stored in memory which is also referred to herein as a “Expected power ratio” value. This total power ratio may be a ratio of (i) the sum of the the total normalized Spectral Power Distribution (SPD) of the emitted optical spectrum 400, and (ii) the sum of the total normalized Spectral Power Distribution (SPD) of the reflected optical colour spectrum 550. This is shown in Table 2 as having a value of 1.37211.

TABLE 2

| Reader Channel | | CH1 | CH2 | CH3 | CH4 | CH5 | CH6 | CH7 | CH8 | Totals |
|---|---|---|---|---|---|---|---|---|---|---|
| Relative | WLED | 1.3007 | 3.9125 | 2.8721 | 4.2996 | 4.4183 | 3.8084 | 2.0301 | 0.6988 | 23.3406 |
| Optical | Reflection | 0.8439 | 3.5246 | 0.4663 | 3.6138 | 4.3915 | 1.96 | 1.5119 | 0.6988 | 17.0108 |
| Power | | | | | | | | | | |
| Levels | | | | | | | | | | |

| | | | | | | | | | |
|---|---|---|---|---|---|---|---|---|---|
| Target WLED to Tag | 1.5412 | 1.1101 | 6.1593 | 1.1898 | 1.0061 | 1.9431 | 1.3428 | 1 | 1.37211 |
| Ratios | | | | | | | | | |

The numbers shown in Table 2 represent relative responses that the optical sensor would measure, not actual power values. For example, when the optical sensor measures the light source, CH1 might give a value of 2000 and when it reads the tag, it will expect to measure a value of 1688 (2000×0.84394) with some error allowed.

At step S602, the CPU 202 receives a user input via the input device 208 instructing the device 102 to emit light from the optical emitter 104. For example, the user may make appropriate selections on a touch sensitive display of the device 102 to navigate through a user interface of a software application running on the CPU 202 to make a selection instructing the optical emitter 104 to emit light. In another example, the user may press a physical button (not shown in the Figures) to trigger the emission of light from the optical emitter 104. In yet another example, the user may provide a voice command to a microphone to instruct the optical emitter 104 to emit light

In response to receiving this user input via the input device 108, the CPU 202 controls the optical emitter 104 to emit light.

The user can position the device such that light emitted from the optical emitter is incident on the tag 150 which is adhered to the object to be authenticated. This causes light to be reflected from the tag 150 back towards the device 102.

At step S604, the CPU 202 determines a reflected optical colour spectrum of the light reflected from the tag based on an output of the optical sensor 106.

In one embodiment, for each channel of the optical sensor 106, the optical sensor measures the total optical power of the received light in the wavelength band associated with that channel and provides an output to the CPU 202 which is one of a plurality of m power levels. Example ADC readings when the optical sensor 106 measures the optical power (P_{TAG}) of the light reflected from the tag 150 are shown below in Table 3.

TABLE 3

| Example Sensor | | | | | | | | | |
|---|---|---|---|---|---|---|---|---|---|
| ADC Readings | CH1 | CH2 | CH3 | CH4 | CH5 | CH6 | CH7 | CH8 | Totals |
| Measured Light | 9104.8 | 27388 | 20105 | 30097 | 30928 | 26659 | 14211 | 4891.7 | 163384 |
| Source | | | | | | | | | |
| Measured Tag | 886.13 | 3700.8 | 489.62 | 3794.5 | 4611 | 2058 | 1587.5 | 733.75 | 17861.3 |
| Reflectance | | | | | | | | | |
| Determined Ratio | 1.5412 | 1.1101 | 6.1593 | 1.1898 | 1.0061 | 1.9431 | 1.3428 | 1 | |
| (Rmeasured) | | | | | | | | | |

For illustration purposes, a scaling factor of 7000 has been used to provide the example ADC reading values. The 7000 scaling factor is the optical power to ADC count conversion. For each channel, the output of the ADC is a count value representative of the optical power of the input signal in that channel. These values, which may be passed from the optical sensor 106 to the CPU 202, are shown in the row of Table 3 labelled “Measured Tag Reflectance”. For each channel, it takes so much optical power (irradiance which may be measured in μW/cm2) to generate each count step (or LSB) of the ADC. The value of 7000 for the scaling factor has been arbitrarily chosen for illustration purposes only.

Taking channel 1 as an example, the measured light source value from an ADC of the optical sensor 106 is a product of (i) the total normalized Spectral Power Distribution (SPD) of the emitted optical spectrum 400 for channel 1 and (ii) the scaling factor (i.e. 1.3007×7000=9104.8). The measured tag reflectance value from an ADC of the optical sensor 106 is a product of (ii) the total normalized Spectral Power Distribution (SPD) of the reflected optical colour spectrum 550 for channel 1, (ii) the scaling factor, and (iii) a PTAG/PLS optical loss ratio value which is characteristic of the environment in which the device 102 is present, the PTAG/PLS optical loss ratio value may have a value of 1% to 100% and for illustration purposes only has been selected as 15% (i.e. 0.8439×7000×0.15=886.13).

For simplicity, these example calculations have assumed flat sensor sensitivity. That is, it has been assumed that all 8 channels of the optical sensor 106 have the same sensitivity to optical power (thus the 7000 scaling factor has been used for each channel). This is not the case in reality since silicon photodiodes have a different sensitivity at different wavelengths i.e. the scaling factor may not be constant for all channels. In embodiments of the present disclosure this is not an issue because the same channel is used to measure both the light emitted from the optical emitter 104 and the light reflected from the tag 150 so any differences in sensitivity apply to both measurements and the outcome of both measurements is used to determine a ratio as will be described in more detail below.

At step S604, for each channel, the CPU 202 then determines a light source to tag power ratio. In particular, the CPU 202 measures the relative response of each channel for the spectra received from the tag 150 versus the spectra emitted by the optical emitter.

It is quite likely that not all of the optical power measured with the flat reflectance reference of the light source (P_{LS}) will be reflected from the tag but the absolute optical power measurements of the channels from the tag reflectance can be adjusted (i.e. normalized) by summing the total optical power across all of the channels (P_{TAG}) and normalizing it to the expected power ratio between the light source and the tag.

That is, for each channel the light source to tag power ratio can be determined by the CPU 202 by the following equation:

$$Rmeasured = \frac{M e a sured Light Source}{\begin{matrix}Measured Tag Reflectance \times \\ ( \frac{\begin{matrix}Total Measured Light Source / \\ Total Measured Tag Reflectance\end{matrix}}{Expected power ratio} )\end{matrix}}$$

Using the values in Tables 2 and 3, the values of the light source to tag ratio can be calculated by the CPU 202 for each channel, these values are shown in the row of Table 3 labelled “Determined Ratio (Rmeasured)”. These values of the light source to tag ratio of each channel are one way of defining the reflected optical colour spectrum of the light reflected from the tag.

For each channel the optical sensor 106 measures the total optical power of the light received by the optical sensor 106 in the wavelength band associated with that channel. With the optical sensor having n channels which are each able to discriminate between m optical power levels, the optical sensor 106 can be used to detect nm different optical signatures. Taking the example whereby an optical sensor has 8 channels each being able to discriminate between 8 power levels, such an optical sensor is able to detect 16,777,216 different optical signatures. It will be appreciated that the number of different optical signatures that the optical sensor can detect is dependent on the number of channels that the optical sensor has and the resolution of the system to reliably discern different power levels. In other embodiments, a processor of the optical sensor 106 may perform the above described calculation of the light source to tag ratios and supply these values to the CPU 202. That is, at step S604 the CPU 202 may determine the reflected optical colour spectrum of the light reflected from the tag based on receiving the light source to tag ratios that are output from the optical sensor 106 (with no further computation necessary).

At step 606, the CPU 202 retrieves an optical signature that is associated with the object that is to be authenticated from memory, For example, the CPU 202 may retrieve the optical signature that is associated with the object from local memory 204. Alternatively, the CPU 202 may retrieve the optical signature that is associated with the object from memory of a remote device (e.g. a server). That is, the CPU 202 retrieves the Target WLED to Tag Ratios (which are shown in Table 2) that are associated with each channel.

At step S608, the CPU 202 determines the authenticity of the object based on comparing the optical signature retrieved from memory and the reflected optical colour spectrum. That is, the CPU 202 compares the calculated ratios (shown in Table 3) against the stored tag target ratios (shown in Table 2). Taking the example of an 8 channel optical sensor, at step S608 the CPU 202 may perform a comparison of the CH1-CH8 spectral power levels of the pre-stored optical signature (represented by the Target WLED to Tag Ratios shown in Table 2) with CH1-CH8 spectral power levels of the reflected optical spectrum (represented by the measured WLED to Tag Ratios shown in Table 3).

If the CPU 202 determines that the optical signature retrieved from memory and the reflected optical colour spectrum match, then the process 600 proceeds to step S610 where the CPU 202 outputs, via the output device 210 an authentication result indicating authentication success (e.g. an authentication success message).

If the CPU 202 determines that the optical signature retrieved from memory and the reflected optical colour spectrum do not match, this indicates that the object is not authentic and the process 600 proceeds to step S612 where the CPU 202 outputs, via the output device 210 an authentication result indicating authentication failure (e.g. an authentication failure message).

The authentication result may be displayed to a user on a display of the device 102. Additionally or alternatively, the CPU 202 may control a speaker to output an audible authentication result.

It will be appreciated that the CPU 202 may utilise a certain degree of tolerance in the determination at step S608. For example, the CPU 202 may determines that the optical signature retrieved from memory matches the reflected optical colour spectrum even if for one or more channels the spectral power level of the reflected optical colour spectrum does not exactly match, but is within a predetermined range of, the power level of the optical signature for that channel. For example, if one or more of channel's light source to tag ratio is within +/−10% of the target light source to tag ratio for that channel, the CPU 202 may determine at step S608 that the optical signature retrieved from memory and the reflected optical colour spectrum match.

To increase the security of the authentication method described herein it is advantageous that the filter design of the optical filter(s) is complex with unique hills and valleys across the spectrum to create a unique signature. Of course, the optical sensor 106 needs to have enough channels to discern the difference in varying patterns.

Embodiments of the present disclosure uses reflected wavelength patterns to authenticate an object to which an authentication tag has been appended. This can be achieved used an authentication reader which can be manufactured with a compact size and thus can reduce the size of the computing device in which the authentication reader is incorporated.

Although the disclosure has been described in terms of preferred embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims. Each feature disclosed or illustrated in the present specification may be incorporated in any embodiments, whether alone or in any appropriate combination with any other feature disclosed or illustrated herein.

1. A device comprising:
an optical emitter for emitting light having an emitted optical spectrum;
an optical sensor for receiving light reflected from a tag attached to an object; and
a processor configured to:
determine a reflected optical colour spectrum of the light reflected from the tag based on an output of the optical sensor;
retrieve an optical signature associated with said object from memory; and
determine the authenticity of said object based on comparing the optical signature and the reflected optical colour spectrum,
wherein the reflected optical colour spectrum comprises, for each of a plurality of wavelength bands, a ratio of optical power of the light reflected from the tag to optical power of the light emitted by the optical emitter.

2. The device according to claim 1, wherein the emitted optical spectrum is associated with a wavelength range which comprises wavelengths of light that the tag is arranged to reflect.

3. The device according to claim 1, wherein the optical sensor is configured to measure light in a measurable wavelength range which comprises wavelengths of light that the tag is arranged to reflect.

4. (canceled)

5. The device according to claim 1, wherein the output of the optical sensor comprises an optical power measurement of the light reflected from the tag for each of the plurality of wavelength bands.

6. The device according to claim 1, wherein the output of the optical sensor comprises the reflected optical colour spectrum.

7. The device according to claim 1, wherein the optical signature comprises, for each of the plurality of wavelength bands, a target ratio of optical power of light reflected from the tag to optical power of light emitted by the optical emitter

8. The device according to claim 1, wherein based on said determination of the authenticity of said object, the processor is configured to output an authentication result to a user of said device via an output device of said device, the authentication result indicating authentication success or authentication failure.

9. The device according to claim 1, wherein the device comprises said memory.

10. The device according to claim 1, wherein a remote device comprises the memory, and the device comprises a communications interface for communicating with the remote device for retrieving said optical signature.

11. The device according to claim 1, wherein the optical emitter emits visible light.

12. The device according to claim 11, wherein the optical emitter is a white LED.

13. A computer implemented method for authenticating an object, the method performed on a device and comprising:
controlling an optical emitter of said device to emit light having an emitted optical spectrum;
determining a reflected optical colour spectrum of light reflected from a tag attached to the object based on an output of an optical sensor of said device;
retrieving an optical signature associated with said object from memory; and
determining the authenticity of said object based on comparing the optical signature and the reflected optical colour spectrum,
wherein the reflected optical colour spectrum comprises, for each of a plurality of wavelength bands, a ratio of optical power of the light reflected from the tag to optical power of the light emitted by the optical emitter.

14. A non-transitory computer-readable storage medium comprising instructions which, when executed by a processor of a device cause the processor to perform the method of claim 13.

15. A system comprising:
a device comprising an optical emitter for emitting light having an emitted optical spectrum; and
a tag attached to an object, the tag comprising:
a base layer of optically absorptive material; and
at least one optical filter, each of the least one optical filter configured to pass light having a wavelength in one or more portions of the emitted optical spectrum through to the base layer and reflect light having a wavelength in remaining portions of the emitted optical spectrum;
wherein the device further comprises:
an optical sensor for receiving light reflected from the tag; and
a processor configured to:
determine a reflected optical colour spectrum of the light reflected from the tag based on an output of the optical sensor;
retrieve an optical signature associated with said object from memory; and
determine the authenticity of said object based on comparing the optical signature and the reflected optical colour spectrum,
wherein the reflected optical colour spectrum comprises, for each of a plurality of wavelength bands, a ratio of optical power of the light reflected from the tag to optical power of the light emitted by the optical emitter.

16. The system according to claim 15, wherein the at least one optical filter is on a surface of the base layer of optically absorptive material.

17. The system according to claim 15, wherein the tag comprises a transparent substrate and the at least one optical filter is on a surface of the transparent substrate,

18. The system according to claim 15, wherein the tag comprises a single optical filter.

19. The system according to claim 15, wherein the tag comprises a plurality of optical filters.

20. The system according to claim 19, wherein the plurality of optical filters are stacked in a vertical arrangement.

21. The system according to claim 19, wherein the plurality of optical filters are arranged in a single horizontal plane in a side by side arrangement.
